(19) United States
(12) Patent Application Publication
(10) Pub. No.: US 2015/0331953 A1
(43) Pub. Date: Nov. 19, 2015

(54) METHOD AND DEVICE FOR PROVIDING SEARCH ENGINE LABEL

(71) Applicant: Beijing Jingdong Century Trading Co., Ltd., Beijing (CN)

(72) Inventors: Wei SHEN, Beijing (CN); Shangkun LIU, Beijing (CN)

(21) Appl. No.: 14/808,215

(22) Filed: Jul. 24, 2015

Related U.S. Application Data
(63) Continuation of application No. PCT/CN2013/091105, filed on Dec. 31, 2013.

(30) Foreign Application Priority Data
Jan. 24, 2013 (CN) 201310027311.2

(51) Int. Cl. G06F 17/30

(52) U.S. Cl. CPC G06F 17/30867; G06F 17/30864; G06F 17/30424; G06F 17/30507

(57) ABSTRACT

A method and device for providing a search engine label are disclosed. In one aspect, the method includes extracting one or more attribute words from a sentence and performing a dependence relationship analysis on the sentence to obtain, for each attribute word, a dependence relationship path from the attribute word to a viewpoint word. The method further includes extracting the viewpoint words corresponding respectively to each of the attribute words in the sentence based on the dependence relationship path and using the attribute words and the viewpoint words to compose the search engine label.

### CROSS REFERENCE TO RELATED APPLICATIONS

This application is a continuation of International Application No. PCT/CN2013/091105, filed Dec. 31, 2013, which claims the benefit under 35 U.S.C. §119 of Chinese Patent Application No. 201310027311.2, filed on Jan. 24, 2013, which are hereby incorporated by reference in their entirety.

### BACKGROUND

1. Technological Field

The described technology generally relates to a method and device for providing a search engine label.

2. Description of the Related Art

At present, when searching a commodity on an electronic commerce website, a user can only perform searching and filtering based on the objective attributes of the commodity, e.g., color, size and the like. However, for searches with subjective tendencies, e.g., if the search word are “a camera with a good cost performance”, generally no results will be returned. As for a subjective semantic search, currently a user generally needs to first find a type or model of a commodity on a generic search engine, and then search for the details of the commodity on the electronic commerce website. This will undoubtedly increase the operational overhead for a user. Further, it can be known through an analysis that most of the search results returned by the generic search engines are based on the evaluations provided by users on the websites such as BBS.

An electronic commerce website itself possesses considerably rich data of user comments, so labels of a search engine is also acquired based on the data of user comments on the electronic commerce website in the standard technology. The main technical route is to automatically identify viewpoint information from the text of comments and analyze the viewpoints for obtaining users' evaluations on the respective attribute features of a commodity, and then associate the excavated evaluations with the commodity to form a search engine label. After obtaining the search engine label, existing search engine techniques can be used to provide search services including data evaluations to the users, wherein a search engine label is capable of indicating a user's subjective intention. Therefore, adopting this search engine label can support the provision of a search service with the subjective intention to a user.

One method for obtaining the above search engine label in the prior art is to firstly identify viewpoint word(s), e.g., good, excellent, not bad and the like, in the text of comments based on a semantic dictionary, then obtain a short sentence which has a proper length and which is relatively semantically integral by extracting the context of the viewpoint word, and further use a semantic analysis tool, e.g., the Stanford University analyzer, to analyze this short sentence to thereby obtain a series of dependence relationships, and finally analyze these dependence relationships to extract the attributive object of the viewpoint word—attribute word(s), e.g., cost performance, appearance and the like. The attribute word is also called “non-predictive adjective” or “distinguishing word”, which is a category of new words separate from nouns, verbs and adjectives as in the traditional grammars. An attribute word only expresses an attribute or characteristic of a person or a thing, and has a distinguishing or classifying function. The attribute word generally can only serve as an attribute and cannot serve as a predicate.

In the above approach, the extraction of the viewpoint word relies on a dictionary, and the extraction of the viewpoint word will not be successful if the word is not included in the dictionary. Therefore, the extent for providing the label is limited. In addition, in the above method, the context extraction for the text based on the viewpoint word is required to be done prior to the extraction of the attribute word, which leads to the decrease inefficiency.

### SUMMARY OF CERTAIN INVENTIVE ASPECTS

In view of the above, one inventive aspect is a method and device for providing a search engine label, which can provide the search engine label within a broader scope and has a comparatively high processing speed.

In order to achieve at least the above objective, further aspects are detailed below including a method for providing a search engine label.

Another aspect is a method for providing a search engine label comprising: extracting one or more attribute words in a sentence; performing a dependence relationship analysis on the sentence to obtain, for each attribute word, a dependence relationship path from the attribute word to a viewpoint word; extracting the viewpoint words corresponding respectively to each of the attribute words in the sentence based on the dependence relationship path; and using the attribute words and the viewpoint words to compose the search engine label.

Optionally, before the step of extracting one or more attribute words in a sentence, the method further comprises: filtering text data based on a preset rule; and acquiring a sentence from the text data.

Optionally, the step of acquiring a sentence from the text data comprises: performing a clause division on the text data based on the punctuations to obtain short clauses; and acquiring the short clauses to serve as the sentence.

Optionally, the step of performing a dependence relationship analysis on the sentence to obtain, for each attribute word, a dependence relationship path from the attribute word to a viewpoint word comprises: performing the dependence relationship analysis on the sentence to obtain a series of dependence relationships of the sentence; obtaining, for each attribute word, the dependence relationship from the attribute word to a viewpoint word via the series of dependence relationships, based on the attribute words and the series of dependence relationships; and traversing the dependence relationships containing the viewpoint words to thereby obtain the dependence relationship path.

Optionally, the step of extracting the viewpoint words corresponding respectively to each of the attribute words in the sentence based on the dependence relationship path comprises: selecting a dependence relationship path having a comparatively high occurrence frequency from the dependence relationship paths; obtaining a dependence relationship rule based on the selected dependence relationship path; and extracting the viewpoint words corresponding to the respective attribute words in the sentence based on the dependence relationship rule.

Optionally, after the step of using the attribute words and the viewpoint words to compose the search engine label, the method further comprises: combining a plurality of labels containing synonymous viewpoint words into one label based on a synonymy.

Another aspect is a device for providing a search engine label.

Another aspect is a device for providing a search engine label comprising: an attribute word extraction module for extracting one or more attribute words in a sentence; a dependence relationship analysis module for performing a dependence relationship analysis on the sentence to obtain, for each attribute word, a dependence relationship path from the attribute word to a viewpoint word; a viewpoint word extraction module for extracting the viewpoint words corresponding respectively to each of the attribute words in the sentence based on the dependence relationship path; and a search engine label module for using the attribute words and the viewpoint words to compose the search engine label.

Optionally, the device further comprises a preprocessing module for filtering text data based on a preset rule, and then acquiring a sentence from the text data.

Optionally, the preprocessing module is further used for performing a clause division on the text data based on the punctuations to obtain short clauses, and then acquiring the short clauses to serve as the sentence.

Optionally, the dependence relationship analysis module is further used for: performing the dependence relationship analysis on the sentence to obtain a series of dependence relationships of the sentence; obtaining, for each attribute word, the dependence relationship from the attribute word to a viewpoint word via the series of dependence relationships, based on the attribute words and the series of dependence relationships; and traversing the dependence relationships containing the viewpoint words to thereby obtain the dependence relationship path.

Optionally, the viewpoint word extraction module is further used for: selecting a dependence relationship path having a comparatively high occurrence frequency from the dependence relationship paths; obtaining a dependence relationship rule based on the selected dependence relationship path; and extracting the viewpoint words corresponding to the respective attribute words in the sentence based on the dependence relationship rule.

Optionally, the device further comprises a normalization module for combining a plurality of labels containing synonymous viewpoint words into one label based on a synonymy.

According to at least one embodiment, the attribute words are excavated and the corresponding viewpoint words are excavated based on the dependence relationships, and the excavated attribute words can also be filtered when no corresponding viewpoint words exist. The at least one embodiment does not rely on a dictionary, and thus facilitates provision of a search engine label within a broader scope; and no context extraction for a sentence is required, which facilitates the improvement of the processing speed.

### BRIEF DESCRIPTION OF THE DRAWINGS

The figures are intended to facilitate the understanding of the described technology and do not constitute improper limitations of the described technology.

FIG. 1 is a schematic diagram of the method for providing a search engine label according to an embodiment.

FIG. 2 is a schematic diagram of the basic structure of the device for providing a search engine label.

### DETAILED DESCRIPTION OF CERTAIN INVENTIVE EMBODIMENTS

The following description will illustrate exemplary embodiments of the described technology with reference to the figures, including various details of the embodiments for a better understanding thereof. The embodiments should be regarded only as exemplary. Therefore, those skilled in the art should appreciate that various changes or modifications can be made with respect the embodiments described herein without departing from the scope and spirit of the described technology. Similarly, for the sake of clarity and conciseness, the descriptions of known functions and structures may be omitted in the descriptions below.

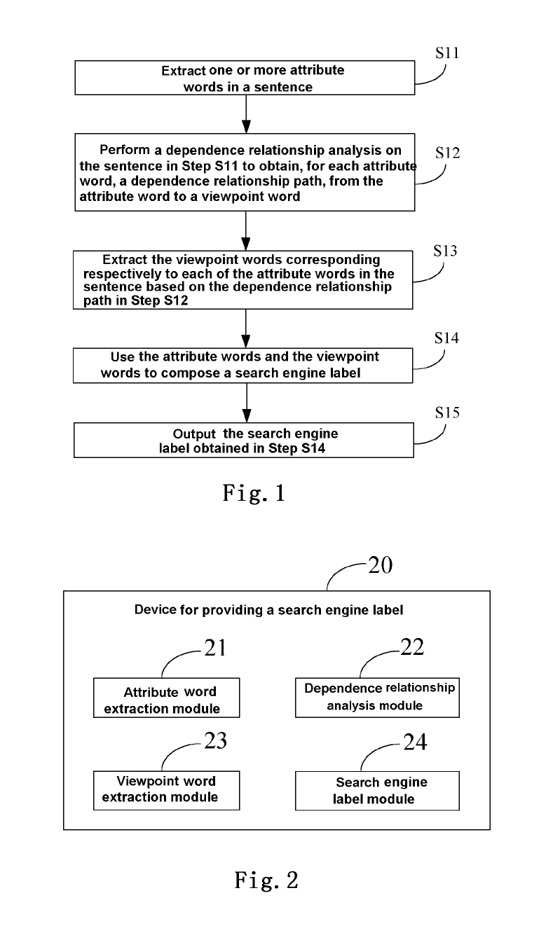

FIG. 1 is a schematic diagram of a method for providing a search engine label according to an embodiment. As shown in FIG. 1, the method mainly includes Step S11 to Step S14.

Step S11 includes extracting one or more attribute words in a sentence. A noun (NN), a verb (VV) and a composite form such as a noun+a verb (NN+VV) in a commenting sentence can be extracted as candidate attribute words by adopting an approach of pattern matching for a part-of-speech . The sentence herein is acquired from the text data, and the text data can be first filtered based on the preset rule, and then clause division can be performed on the text data based on the punctuations to obtain short clauses, and the short clauses be used as the sentence in this step. In the above example, the text data is described as being the information of commodity comments on an electronic commerce websites, and as such, the above filtering step would be to preprocess the original comments extracted from the websites, filter out the meaningless phrases or sentences such as marketing advertisements, stop words and default comments in these comments based on certain rules, and then remove phrases or sentences having extensive repetitions in the same comment.

Step S12 includes performing a dependence relationship analysis on the sentence in Step S11 to obtain, for each attribute word, a dependence relationship path from the attribute word to a viewpoint word. Specifically, this stepcan include: first performing the dependence relationship analysis on the above sentence to obtain a series of dependence relationships of the sentence, then obtaining, for each attribute word, the dependence relationship from the attribute word to a viewpoint word via the series of dependence relationships, based on the attribute words and the series of dependence relationships, and finally traversing the dependence relationships containing the viewpoint words to thereby obtain the dependence relationship path. It can be seen that in this step, a plurality of passing dependence relationships are utilized to form the dependence relationship path, which facilitates a deep excavation or comprehensive mining of the viewpoint words.

Step S13 includes extracting the viewpoint words corresponding respectively to each of the attribute words in the sentence based on the dependence relationship path in Step S12. If no viewpoint word is extracted for a certain attribute word, this attribute word will be deleted from the set of attribute words obtained at Step S11. Specifically, this step can include: firstly selecting a dependence relationship path having a comparatively high occurrence frequency from the dependence relationship paths, and then obtaining a dependence relationship rule based on the selected dependence relationship path, and finally extracting the viewpoint words corresponding to the respective attribute words in the sentence based on the dependence relationship rule.

Step S14 includes using the attribute words and the viewpoint words to compose the search engine label. The attribute words herein refer to the set of attribute words after Step S13. After this step, a combination can be performed based on the synonyms of the viewpoint words in the search engine label, i.e., combining a plurality of labels containing synonymous viewpoint words into one label based on their synonymy. For example, the labels “good cost performance”, “high cost performance” and “matchless cost performance” are combined into the label “high cost performance”.

Labels can used to establish an index for the commodities for searches by users. However, in some situations, the search word inputted by a user himself or herself may be not one obtained in the steps as shown in FIG. 1, so it may be needed to further perform Step S15.

Step S15 includes outputting the search engine label obtained in Step S14. At this step, the search engine label is presented in a human-computer interface, e.g., on a web page, of a terminal device used by the user, and the user can submit this search engine label to the search engine to thereby start a search by clicking on this search engine label, whereby the user can achieve filtering of the commodities based on the various attribute words presented on the page.

FIG. 2 is a schematic diagram of the basic structure of the device for providing a search engine label according to an embodiment. As shown in FIG. 2, a device 20 for providing a search engine label basically comprises an attribute word extraction module 21, a dependence relationship analysis module 22, a viewpoint word extraction module 23, and a search engine label module 24. The attribute word extraction module 21 is used for extracting one or more attribute words in a sentence. The dependence relationship analysis module 22 performs a dependence relationship analysis on the sentence to obtain, for each attribute word, a dependence relationship path from the attribute word to a viewpoint word. The viewpoint word extraction module 23 extracts the viewpoint words corresponding respectively to each of the attribute words in the sentence based on the dependence relationship path. The search engine label module 24 uses the attribute words and the viewpoint words to compose the search engine label.

The device 20 for providing a search engine label can further comprise a preprocessing module (not shown in the figure) for filtering text data based on a preset rule, and then obtaining a sentence from the text data. The preprocessing module can be further used for performing a clause division on the text data based on the punctuations to obtain short clauses, and then acquiring the short clauses to serve as the sentence.

The device 20 for providing a search engine label can further comprise a normalization module (not shown in the figure) for combining a plurality of labels containing synonymous viewpoint words into one label based on a synonymy.

The dependence relationship analysis module 22 can be further used for: performing the dependence relationship analysis on the sentence to obtain a series of dependence relationships of the sentence; obtaining, for each attribute word, the dependence relationship from the attribute word to a viewpoint word via the series of dependence relationships, based on the attribute words and the series of dependence relationships; and traversing the dependence relationships containing the viewpoint words to thereby obtain the dependence relationship path.

The viewpoint word extraction module 23 can be further used for: selecting a dependence relationship path having a comparatively high occurrence frequency from the dependence relationship paths; obtaining a dependence relationship rule based on the selected dependence relationship path; and extracting the viewpoint words corresponding to the respective attribute words in the sentence based on the dependence relationship rule.

According to at least one embodiment of the described technology, the attribute words can be excavated and the corresponding viewpoint words can be excavated based on the dependence relationships, and meanwhile the excavated attribute words can also be filtered when no corresponding viewpoint words exist. The at least one embodiment does not rely on a dictionary, and thus facilitates provision of a search engine label within a broader scope; and since no context extraction for a sentence is required, it can also improve the processing speed.

The above descriptions depicts the basic principles of the described technology with reference to the specific embodiments. However, it is necessary to point out that those skilled in the art shall understand that all or any step or part of the method and device of the described technology can be realized through hardware, firmware, software or a combination thereof in any computing device (including a processor, a storage medium, etc.) or a network of a computing device. This can be realized by those skilled in the art by applying their basic programming skills after they read the descriptions of the present invention.

So, the described technology can be also implemented by running a program or a set of programs on any computing device. The computing device can be a generic device already known. For example, the computing device can include a memory circuit which can store each of the attribute word extraction module 21, the dependence relationship analysis module 22, the viewpoint word extraction module 23, and the search engine label module 24; and a processor circuit which can execute the respective modules 21-24. Therefore, the described technology can be also achieved only by providing a program product including program codes implementing the method or device. That is to say, such a program product also constitutes the described technology, and a storage medium storing such a program product also constitutes the described technology. Obviously, the storage medium can be any known storage medium or any storage medium developed in the future.

It is further necessary to point out that in the device and method of the described technology, the respective parts or the respective steps obviously can be decomposed and/or recombined. These decompositions and/or recombinations shall be regarded as equivalent solutions of the described technology. And the steps performing the above series of processings can be naturally performed in a time sequence based on the described sequence, but are not necessarily performed in the time sequence. Some steps can be performed in parallel or independently of each other.

The above specific embodiments do not constitute a restriction on the scope of protection of the inventive technology. Those skilled in the art shall understand that, based on design requirements and other factors, various modifications, combinations, sub-combinations and substitutions can occur. Any modifications, equivalent substitutions, improvements, etc. within the spirit and principle of the inventive technology shall be included in the scope of protection of the inventive technology.

What is claimed is:

1. A method for providing a search engine label, comprising:
extracting one or more attribute words from a sentence;
performing a dependence relationship analysis on the sentence to obtain a dependence relationship path, with respect to each of the attribute words, from each of the attribute words to a corresponding viewpoint word;
extracting the viewpoint words respectively corresponding to each of the attribute words in the sentence based on the dependence relationship path; and
using the attribute words and the viewpoint words to compose the search engine label.

2. The method according to claim 1, wherein prior to the extracting the one or more attribute words from the sentence, the method further comprises:
filtering text data based on a preset rule; and
acquiring a sentence from the text data.

3. The method according to claim 2, wherein the acquiring the sentence from the text data comprises:
performing a clause division on the text data based on punctuation included in the text data to obtain short clauses; and
acquiring the short clauses to serve as the sentence.

4. The method according to claim 1, wherein the performing the dependence relationship analysis on the sentence to obtain the dependence relationship path, with respect to each of the attribute words, from each of the attribute words to a corresponding viewpoint word comprises:
performing the dependence relationship analysis on the sentence to obtain a series of dependence relationships of the sentence;
obtaining, for each of the attribute words, the dependence relationship from the attribute word to the corresponding viewpoint word via the series of dependence relationships, based on the attribute words and the series of dependence relationships; and
traversing the dependence relationships containing the viewpoint words to thereby obtain the dependence relationship path.

5. The method according to claim 1, wherein the extracting the viewpoint words respectively corresponding to each of the attribute words in the sentence based on the dependence relationship path comprises:
selecting a dependence relationship path having a comparatively high occurrence frequency from the dependence relationship paths;
obtaining a dependence relationship rule based on the selected dependence relationship path; and
extracting the viewpoint words corresponding to the respective attribute words in the sentence based on the dependence relationship rule.

6. The method according to claim 1, wherein after the using the attribute words and the viewpoint words to compose the search engine label, the method further comprises combining a plurality of labels containing synonymous viewpoint words into one label based on a synonymy of the viewpoint words.

7. A device for providing a search engine label, comprising:
an attribute word extraction module for extracting one or more attribute words from a sentence;
a dependence relationship analysis module for performing a dependence relationship analysis on the sentence to obtain, for each of the attribute words, a dependence relationship path from the attribute word to a corresponding viewpoint word;
a viewpoint word extraction module for extracting the viewpoint words respectively corresponding to each of the attribute words in the sentence based on the dependence relationship path; and
a search engine label module for using the attribute words and the viewpoint words to compose the search engine label.

8. The device according to claim 7, further comprising a preprocessing module for filtering text data based on a preset rule, and then acquiring a sentence from the text data.

9. The device according to claim 8, wherein the preprocessing module is further for performing a clause division on the text data based on punctuation included in the text data to obtain short clauses, and then acquiring the short clauses to serve as the sentence.

10. The device according to claim 7, wherein the dependence relationship analysis module is further for:
performing the dependence relationship analysis on the sentence to obtain a series of dependence relationships of the sentence;
obtaining, for each of the attribute words, the dependence relationship from the attribute word to the corresponding viewpoint word via the series of dependence relationships, based on the attribute words and the series of dependence relationships; and
traversing the dependence relationships containing the viewpoint words to thereby obtain the dependence relationship path.

11. The device according to claim 7, wherein the viewpoint word extraction module is further for:
selecting a dependence relationship path having a comparatively high occurrence frequency from the dependence relationship paths;
obtaining a dependence relationship rule based on the selected dependence relationship path; and
extracting the viewpoint words corresponding to the respective attribute words in the sentence based on the dependence relationship rule.

12. The device according to claim 7, further comprising a normalization module for combining a plurality of labels containing synonymous viewpoint words into one label based on a synonymy of the viewpoint words.
